(19) United States
(12) Patent Application Publication
(10) Pub. No.: US 2026/0312924 A1
(43) Pub. Date: Oct. 8, 2026

(54) SYSTEM AND METHOD FOR AUTOMATED WELLNESS AND STATUS MONITORING AND ALERT NOTIFICATION

(71) Applicant: GGC Holdings LLC, Naples, FL (US)

(72) Inventor: Gregory Cueter, Naples, FL (US)

(21) Appl. No.: 19/179,066

(22) Filed: Apr. 15, 2025

Related U.S. Application Data
(60) Provisional application No. 63/660,906, filed on Jun. 17, 2024.

(51) Int. Cl. H04L 51/02; G06F 16/335

(52) U.S. Cl. CPC H04L 51/02; G06F 16/337

(57) ABSTRACT

The present disclosure relates to a method for monitoring the status of an individual. The method includes receiving information about a targeted individual. The method also includes receiving profile information for the targeted individual. The method further includes sending a first automated inquiry to the targeted individual based on the profile information. The method also includes receiving a response from the targeted individual based on the first automated inquiry. The method in addition includes sending one or more additional automated inquiries to the monitored individual based on the profile information. The method includes determining that a response to the one or more additional automated inquiries was not received based on a predetermined threshold. The method further includes sending an automated notification to the designated contact.

### CROSS-REFERENCE TO RELATED APPLICATION

This application is based upon and claims priority to Provisional Application No. 63/660,906 filed on Jun. 17, 2024, the entire content thereof is incorporated herein by reference in its entirety.

### FIELD OF THE INVENTION

This application relates generally to a wellness and status monitoring system and, more particularly, to an automated system and method for monitoring the wellness and status of individuals and providing notifications to designated contacts, including emergency services, based on user-defined parameters and responses.

### BACKGROUND OF THE INVENTION

Keeping track of the wellness and safety status of individuals, particularly those who are elderly, living alone, or have medical conditions, has become increasingly important in modern society. As families become more geographically dispersed and people live longer, often independently, there is a growing need for reliable ways to monitor the well-being of loved ones from a distance.

Current technologies for monitoring individuals typically rely on wearable devices or complex systems that can be challenging for some users, especially older adults, to adopt and use consistently. Wearable devices like smartwatches or medical alert pendants require the individual to remember to put on and charge the device daily. These devices may be uncomfortable, stigmatizing, or simply forgotten, leading to gaps in monitoring.

More comprehensive home monitoring systems often involve multiple sensors, cameras, or other equipment installed throughout a residence. While potentially effective, these systems can be expensive, intrusive, and complicated to set up and maintain. Many older adults or those with cognitive impairments may struggle to interact with or properly utilize such technologies.

Additionally, existing solutions frequently lack flexibility in terms of customization and communication preferences. They may not account for individual routines, desired check-in frequencies, or preferred methods of contact. This can result in unnecessary alerts or missed opportunities to intervene when help is truly needed.

Accordingly, there is a need for a system to help keep track of an individual's wellness and status that overcomes these and other challenges.

### SUMMARY

Examples of the present disclosure provide a system and method for automated wellness and status monitoring and alert notification.

According to a first aspect of the present disclosure, a computer-implemented method for monitoring the status of an individual is provided. The method may be implemented on a mobile device, wearable technology, server, cloud-based platform, computer system, or system capable of processing data and communicating over a network. The method may include receiving information about a targeted individual. The information about the targeted individual may include contact information of an individual to be monitored and a designated contact for the individual. The method may further include receiving profile information for the targeted individual. The profile information may include information about communication preferences for the targeted individual. The method may also include sending a first automated inquiry to the targeted individual based on the profile information. The method may additionally include receiving a response from the targeted individual based on the first automated inquiry. The method may also include sending one or more additional automated inquiries to the monitored individual based on the profile information. The method may further include determining that a response to the one or more additional automated inquiries was not received based on a predetermined threshold. The method may also include sending an automated notification to the designated contact.

According to a second aspect of the present disclosure, a computing device, such as a server, is provided. The computing device may include one or more processors, a non-transitory computer-readable memory storing instructions executable by the one or more processors. The one or more processors may be configured to receive information about a targeted individual. The information about the targeted individual may include contact information of an individual to be monitored and a designated contact for the individual. The one or more processors may also be configured to receive profile information for the targeted individual. The profile information may include information about communication preferences for the targeted individual. The one or more processors may also be configured to send a first automated inquiry to the targeted individual based on the profile information. The one or more processors may further be configured to receive a response from the targeted individual based on the first automated inquiry. The one or more processors may additionally be configured to send one or more additional automated inquiries to the monitored individual based on the profile information. The one or more processors may also be configured to determine that a response to the one or more additional automated inquiries was not received based on a predetermined threshold. The one or more processors may further be configured to sending an automated notification to the designated contact.

According to a third aspect of the present disclosure, a non-transitory computer-readable storage medium having stored therein instructions is provided. When the instructions are executed by one or more processors of the apparatus, the instructions may cause the apparatus to perform receiving information about a targeted individual, wherein the information about the targeted individual comprises contact information of an individual to be monitored and a designated contact for the individual. The contact information may include the targeted individuals mobile phone number or email address. The instructions may also cause the apparatus to receive profile information for the targeted individual. The profile information may include information about communication preferences for the targeted individual. The instructions may further cause the apparatus to send a first automated inquiry to the targeted individual based on the profile information. The instructions may in addition cause the apparatus to receive a response from the targeted individual based on the first automated inquiry. The instructions may also cause the apparatus to send one or more additional automated inquiries to the monitored individual based on the profile information. The instructions may further cause the apparatus to determine that a response to the one or more additional automated inquiries was not received based on a predetermined threshold. The instructions may in addition cause the apparatus to send an automated notification to the designated contact.

These and other aspects and advantages will become apparent to those of ordinary skill in the art by reading the following detailed description, with reference where appropriate to the accompanying drawings. Further, it should be understood that the foregoing summary is merely illustrative and is not intended to limit in any manner the scope or range of equivalents to which the appended claims are lawfully entitled.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram of an environment, according to an example of the present disclosure.

FIG. 2 is a block diagram of a status monitoring process, according to an example of the present disclosure.

FIG. 3 is a flow chart illustrating a method for monitoring an individual's status, according to an example of the present disclosure.

FIG. 4 is a block diagram of a computing system, according to an example of the present disclosure.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the disclosure as recited in the appended claims.

The terminology used in the present disclosure is for the purpose of describing particular embodiments only and is not intended to limit the present disclosure. As used in the present disclosure and the appended claims, the singular forms “a,” “an,” and “the” are intended to include the plural forms as well, unless the context clearly indicates otherwise. It shall also be understood that the term “and/or” used herein is intended to signify and include any or all possible combinations of one or more of the associated listed items.

The present disclosure relates to a system and method for wellness and status monitoring and alert notification of individuals. The system is designed to facilitate periodic checks on the well-being of users and their loved ones, such as children, elderly parents, or friends. Users can create a profile, add individuals for wellness and status updates, and customize communication preferences, including the method and frequency of contact, as well as the number of non-response attempts before the system automatically notifies a designated contact. The system offers a user-friendly interface, with response options via text, email, or landline, and includes an emergency feature that can contact emergency services if a serious issue is determined. This system aims to provide peace of mind and timely intervention for a wide range of users concerned with personal and family wellness and status management.

In one or more embodiments, the status monitoring tool is a mobile application used for ensuring the well-being of a user's loved ones and even themselves. The application is developed to provide peace of mind by allowing users to conduct periodic wellness checks on individuals, whether it's children, parents, friends, or even themselves. The process begins with a simple account creation, where a user can set up their profile with basic information. Next, a user can add individuals they wish to keep track of, specifying their contact details and the user's preferred method of communication. They can further tailor the frequency of updates and set thresholds for non-responses. Should no reply be received after the specified attempts, the system automatically notifies the designated person, detailing the attempts made. With its user-friendly interface and customizable features, the system caters to a wide range of users, from concerned family members, friends, even individuals monitoring their own health, ensuring timely intervention when needed.

### Welcome Screen

Upon entering the application, a user is greeted by the system. It is designed to enable periodic status checks on individuals, including children, parents, loved ones, and even the user themselves, ensuring no concerns go unnoticed. These can include wellness or overall status concerns.

### Account Creation

A user can hit enter to create their account, can complete the normal process, including choosing a username and password and can fill out an application with their name, gender, age, phone number, and email address.

### Individuals for Status Updates

A user can proceed to an “Individuals” section where they can list people they want the system to send updates to. Fill out a form for each individual including their name, relation to their, gender, age, phone number, and email address.

In an embodiment, the application can include predefined profiles for monitoring individuals. For example, there could be a predefined profile for an elderly individual, a sick individual, a child, and a self-profile. The elderly individual profile can include predefined settings to send notifications tailored to an elderly individual in order to gain their attention and receive a response. For example, the elderly profile can include a notice about the current news and a link to open a news article, which would not only open a browser for the article, but would notify the application that the user has opened the article. The application can further send queries to the patient being monitored to acquire about their wellness and status.

In another example, a child profile can be predefined where the time and manner of notifications are preset to include times the child may be in school, practice, or at home. The notifications can also include specific notes that a parent may want to send the child.

In another example, a self-profile can be predefined where a user wants to make sure someone is notified if they don't respond to preset messages. For example, the predefined settings can include specific messages being sent out at specific times when the user is most at risk for injury or would need help. Such times can include when the user is alone at home, doing activities that may lead to injuries, like taking a shower or cooking, and when the user just wants to check in to the application.

### Communication Preferences

In an embodiment, a user can choose how the system contacts these individuals (via text, email, landline or combination of these). Specify the frequency of contact and the duration to wait for a response before sending another request (options include hours or days). Additionally, set the number of attempts or non-responses allowed before notifying the designated person. Should the individual fail to respond initially, the system is equipped to initiate a follow-up request after a specified period, ranging from hours to days later. Following a predetermined number of attempts without a response, the system autonomously triggers a notification to the designated individual, informing them of the actions taken and the absence of any response from the individual. During a prompt, individuals are presented with three clear response options:
1. “I am fine,”
2. “Not well,” or
3. “Need help,” facilitating easy and immediate communication of their status.

Other responses may be used to help provide the wellness and status of the person being monitored.

### Notification Process

If no response is received after the specified attempts, the system will automatically notify the designated person via email, text, landline or any combination. The notification includes details of the attempts made along with dates and times. After completing its cycle, the system ceases further action until prompted.

The system has the capability to contact emergency services such as police, fire, and 911 automatically, if necessary, thereby ensuring swift action without human intervention.

In another embodiment, the no-response notification can also trigger the use of other devices, such as home cameras. This may allow, based on the person being monitored giving prior permission, the ability to see a live feed of a home camera.

### Target Audience

Parents concerned about their children's status or well-being. Children monitoring their parents' well-being. Individuals looking out for loved ones. Friends checking up on friends. Self-checking for personal wellness awareness.

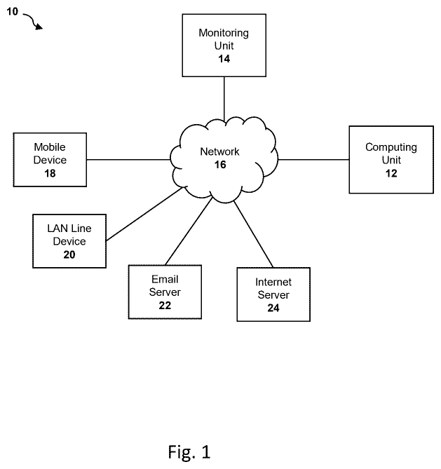

Turning now to the figures, FIG. 1 shows a block diagram of a monitoring system 10, according to an embodiment of the present disclosure. The environment 10 includes a computing unit 12, a monitoring unit 14, a network 16, a mobile device 18, a Local Area Network (LAN) line device 20, an email server 22, and an internet server 24. The system 14 can communicate with each of the components in the environment 10 through the network 16. A user may set the monitoring unit 14 settings, for example, through the computing unit 12 or a mobile device 18. The person to be notified may be notified through the mobile device 18, LAN line device 20, email server 22 (through an email), or through an internet server 24 (that notifies, for example, a person using their social media account).

The monitoring system 10 is designed to provide a comprehensive and flexible platform for wellness and status monitoring across various communication channels. The computing unit 12 serves as the central processing hub, managing user profiles, scheduling check-ins, and analyzing responses. It interfaces with the monitoring unit 14, which handles the actual communication and alert generation processes. The network 16 enables seamless data transfer between components. This could be a combination of cellular networks, Wi-Fi, and broadband internet, ensuring robust connectivity. The mobile device 18 represents smartphones or tablets used by both the monitored individuals and their designated contacts, allowing for real-time interactions and alerts. The LAN line device 20 caters to users who prefer traditional telephone communication, especially important for elderly individuals. The email server 22 facilitates asynchronous communication, sending detailed reports and non-urgent updates. The internet server 24 expands the system's reach by integrating with social media platforms and web-based applications, providing additional channels for notifications and interactions. This multi-faceted approach ensures that the monitoring system can adapt to various user preferences and technological capabilities, maximizing its effectiveness in maintaining consistent communication and prompt alert delivery when needed.

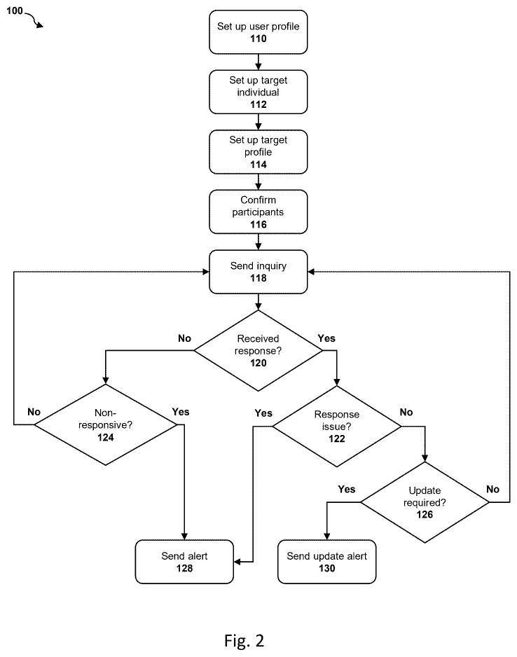

FIG. 2 shows a notification process 100 in accordance with the present disclosure. The process can be implemented on a monitoring environment through the use of a mobile device application or through a web browser on a computer system.

In step 110, a user profile is se tup. A user may download the mobile application on a mobile device, access a web-based platform, or utilize another interface to set up a user profile. The profile set up process may involve creating an account with a username and password, and providing basic personal information such as name, age, gender, contact details (phone number and email address), and potentially emergency contact information.

The user may be a parent, guardian, caregiver, friend, or any individual who wishes to monitor the status of one or more individuals, including themselves. During profile setup, users may also be prompted to specify their role (e.g., parent, adult child of elderly parent, self-monitoring individual) and indicate their primary concerns or reasons for using the monitoring system.

In step 112, a target individual is set up. The user configures the system to monitor the status of a target individual by creating a target individual profile and entering required information. The target individual can be a child, elderly parent, spouse, friend, colleague, client, patient, or even the user themselves for self-monitoring purposes.

The user provides information for the target individual, including name and contact information, such as phone number and email address. Other information that may be collected is the target individual's full name and relationship to the user, age and gender, contact information (phone number, email address, and potentially physical address), preferred communication method (e.g., text, email, voice call), any special needs, and daily routines or schedules that may impact monitoring.

Additionally, the user designates at least one designated contact for the individual who can be notified when the status of the target individual is critical or needs review. For this contact individual, the user provides the full name and relationship to the target individual and contact information (phone number, email address).

The system may allow for multiple contact individuals to be added, with options to set a notification hierarchy or specific scenarios for contacting each person. Users might also have the option to import contact information from their device's address book or other connected accounts to streamline the set-up process.

In step 114, a target profile is set up. In step 114, a target profile is set up. The user chooses from a set of predetermined profiles. The target profiles are predefined profiles for individuals such as a child, elderly parent, spouse, friend, colleague, client, patient, or even the user themselves. The profiles have information about when and how to contact the target individual, what the inquiry message includes, how to follow up with the target individual if there is no initial response, and how and when to contact the contact individual about the target individual and what information to send.

The profile may include specific monitoring parameters for the target individual, such as frequency of check-ins, customized messages, and thresholds for triggering alerts, preferred method and time for receiving notifications, any specific instructions or protocols to follow in case of an alert. The profile may also include options for customizing notification preferences, setting privacy controls, and agreeing to terms of service and data usage policies. Additionally, the system may offer a tutorial or guided setup to help users understand the full range of features and how to effectively use the monitoring unit.

In step 116, participants are confirmed. The monitoring unit 14 initiates a crucial verification process using the target individual information and target profile to ensure all parties are willing and able to participate in the status monitoring system. This confirmation step is designed to maintain transparency, obtain informed consent, and establish clear expectations for all involved parties.

The monitoring unit sends carefully crafted messages to both the target individual and the designated contact individual(s) through multiple channels, typically including text messages and emails. These communications provide a comprehensive overview of the monitoring system, detailing its purpose, functionality, and the specific role each participant will play. For the target individual, the message explains the nature and frequency of status inquiries they can expect to receive, how their responses will be used, and the potential consequences of non-response. For contact individuals, the message outlines their responsibilities, the circumstances under which they may be notified, and the types of information they might receive.

Crucially, these messages explicitly request each participant's consent to be part of the monitoring system. The monitoring unit provides clear instructions on how to confirm or decline participation, ensuring that all parties have the opportunity to make an informed decision. If all participants confirm their willingness to be involved, the process advances to step 118, and the monitoring system becomes active. However, if any individual declines participation or fails to respond within a specified timeframe, the user who initiated the monitoring is promptly notified that the monitoring cannot commence as planned. This notification includes information on which participants have not confirmed, allowing the user to potentially address concerns, modify the monitoring parameters, or choose alternative participants if appropriate.

The message may include a variety of personalized and context-appropriate inquiries designed to elicit a response from the target individual. Examples include simple greetings like “Good morning, how are you?” or “Hi Greg, how are you?”, which can be tailored with the individual's name for a more personal touch. Other messages might be more specific, such as “Did you have breakfast this morning?” or “How's your energy level right now?”. For elderly individuals, messages could include prompts about daily activities, like “Have you gone for your walk today?” or “Did you enjoy your book club meeting?”. For children, messages might ask about school or activities, such as “How was soccer practice?” or “Did you finish your homework?”. The system can also send seasonal or event-specific messages like “It's hot today, are you staying hydrated?” or “Happy birthday! How's your special day going?”. In cases where more detailed information is needed, the message might include multiple-choice options, such as “How would you rate your mood today? A) Great, B) Good, C) Okay, D) Not good”. These varied message types allow for flexibility in monitoring different aspects of an individual's well-being while maintaining engagement and encouraging regular responses.

To further enhance engagement and increase response rates, the system can incorporate targeted marketing elements into the messages. These can include personalized advertisements based on the individual's interests or needs, such as “Have you tried the new senior yoga class at the community center? First session free!”, or “Don't forget to use your 20% off coupon at the pharmacy today!”. For younger users, messages might include promotions for popular apps or games, like “New level unlocked in Math Quest—check it out and let us know how you do!”. Seasonal discounts on relevant products or services can also be integrated, such as “Stay cool with 15% off fans at Home Depot this week. How are you keeping comfortable in this heat?”. These marketing elements not only serve to capture the individual's attention but also provide potential value, encouraging them to engage with the messages and respond more consistently to the status and wellness inquiries.

The system can interface with advertising firms and marketing platforms to dynamically customize and optimize the promotional content included in the predefined messages. This integration allows for real-time bidding and ad selection based on the target individual's profile, current context, and response history. For example, the system might communicate with a programmatic advertising platform, sharing anonymized user data such as age, interests, and recent interactions. The platform then selects the most relevant and engaging ad from its inventory, which could be anything from local business promotions to national brand campaigns. In an embodiment, the system can leverage machine learning algorithms to analyze which types of ads generate the highest response rates for different user segments, continuously refining its ad selection criteria. Additionally, it can work with advertising firms to create custom ad campaigns specifically designed for status monitoring contexts, ensuring that the promotional content aligns with the overall goal of encouraging user engagement. By creating this symbiotic relationship between status monitoring and targeted advertising, the system not only enhances its effectiveness in maintaining user engagement but also creates a potential revenue stream to support its operations and development.

The time to be sent includes a range of strategically chosen intervals throughout the day to ensure regular check-ins without becoming intrusive. Morning during breakfast time (typically between 7:00 AM and 9:00 AM) is often ideal for assessing how the individual is starting their day. After lunch (around 1:00 PM to 2:00 PM) provides an opportunity to check on midday activities and energy levels. Before dinner (approximately 5:00 PM to 7:00 PM) allows for a review of the day's events and an assessment of evening plans. Other times can include mid-morning for those who might sleep later, mid-afternoon to combat post-lunch fatigue, early evening for those with later schedules, or even a gentle late-night check-in for individuals prone to nighttime issues. The system can also be configured to send messages at specific times relevant to an individual's routine, such as shortly after school ends for children, following regular medication times for those on specific regimens, or coinciding with the end of a work shift for employed individuals. Additionally, the timing can be adjusted based on weekdays versus weekends, accounting for different schedules and activities.

In step 118, an inquiry is sent. The monitoring system automatically dispatches a status inquiry to the target individual based on the carefully configured parameters established in their profile. This inquiry is sent at a predefined time that has been strategically chosen to align with the individual's daily routine and maximize the likelihood of a prompt response. The content of the message is predetermined, drawing from a library of templates tailored to the specific profile selected for the target individual. These messages are crafted to be engaging, relevant, and appropriate for the individual's circumstances, whether they're a child, an elderly parent, or someone with specific wellness concerns. The system may employ various communication channels, such as text messages, emails, or even automated voice calls, depending on the individual's preferences and accessibility needs. The inquiry might be a simple wellness check, a reminder about medication or appointments, or a more detailed questionnaire about specific aspects of the individual's status or activities.

In step 120, it's determined is a response has been received. The monitoring system checks for a response from the target individual. This crucial step involves a real-time assessment of whether the inquiry sent in step 118 has elicited a reply within a predetermined timeframe. The system continuously monitors incoming communications across all configured channels, such as text messages, emails, or voice responses, depending on the method used for the initial inquiry. The response window is typically set based on the target individual's profile and the nature of the inquiry, allowing for reasonable delays while still ensuring timely follow-up if needed. If a response is detected, the system logs the time, content, and method of the response for further analysis. This data is used to update the individual's status, adjust monitoring patterns if necessary, and provide insights into the individual's well-being and communication habits. If no response is received within the specified timeframe, the system flags this as a potential concern, triggering the next steps in the monitoring protocol, which may include sending follow-up messages, alerting designated contacts, or escalating the situation based on predefined criteria in the individual's profile. If a response was received, the process will go to step 122, otherwise, the process will go to step 124.

In step 122, it's determined if a response issue is detected. This involves a nuanced analysis to determine if a response issue is detected. This process goes beyond simply checking for the presence of a response and delves into the content and nature of the reply received.

In an embodiment, the system may employ advanced natural language processing algorithms to interpret the response message, comparing it against a set of predefined standard responses such as “yes” or “I'm fine.” If the response deviates from these expected patterns, the contact individual may be contacted in step 128, otherwise step 126 is taken. The analysis considers factors like unusual phrasing, unexpected emotional tone, or specific keywords that might indicate distress or confusion. For instance, a response like “feeling a bit off today” would be flagged for further attention by the contact individual. The system also takes into account the individual's typical response patterns, as established over time, to identify any significant deviations. This sophisticated assessment allows the monitoring system to distinguish between routine communications and potential issues that may require immediate attention or follow-up, ensuring that subtle signs of trouble are not overlooked while also avoiding unnecessary alerts for normal variations in responses.

In step 124, it's determined if the target individual is non-responsive. This includes a comprehensive assessment to determine if the target individual is non-responsive. This determination is based on a carefully structured protocol designed to balance prompt intervention with respect for the individual's autonomy and potential legitimate reasons for delayed responses. The process typically involves sending multiple messages through various communication channels over a predefined period. For instance, the system might initially send a text message, followed by an email if no response is received within a specified timeframe, and finally attempt a phone call or voice message. Each attempt is logged and timed, with the system adhering to preset intervals between communications to avoid overwhelming the individual. The duration of this escalation process is tailored to the individual's profile, considering factors such as their typical response patterns, daily routines, and any known circumstances that might affect their ability to respond. If, after exhausting all predefined communication attempts and waiting for the stipulated period, there is still no response, the system classifies the individual as non-responsive. This triggers the transition to step 128, initiating the alert protocol. However, if a response is received at any point during this process, the system reverts to step 118, resetting the monitoring cycle and potentially adjusting future inquiry timing based on the observed response pattern.

In step 126, its determined if an update is required. This involves determining if an update is required for the contact individual or user regarding the target individual's status. This decision-making process is based on multiple factors, carefully balancing the need for regular communication with the desire to avoid unnecessary notifications. The system considers predefined time intervals, which may be set to weekly, monthly, or quarterly cycles, depending on the monitoring intensity required for the specific individual. These regular updates ensure that even in the absence of immediate concerns, those responsible for the individual's care remain informed of their overall status and any subtle changes over time.

Additionally, the system references the target individual's profile, which contains customized parameters for update frequency and content. These profile-based triggers might be tied to specific events or behavioral patterns unique to the individual. For instance, a profile might stipulate more frequent updates during a holiday or weather event. The system also analyzes the accumulated data from recent interactions, potentially triggering an update if it detects a pattern of minor concerns that, while not individually alarming, might be significant when viewed collectively. This nuanced approach ensures that updates are not just time-based, but also context-sensitive, providing meaningful insights to caregivers and allowing for proactive intervention when necessary. If an update is due, step 130 is taken, otherwise, step 118 is taken.

In step 128, an alert is sent. The system, drawing upon the carefully configured profile and up-to-date contact information, dispatches an alert to the designated contact individual. This includes a comprehensive package of information tailored to prompt immediate and appropriate action. It can begin with a predetermined text, strategically crafted to convey urgency while maintaining clarity, such as “URGENT: Status Check Required for [Target Individual's Name].” This is followed by a concise yet detailed status update of the target individual, which may include the nature of the concern (e.g., “non-responsive to multiple check-ins”), a timeline of recent monitoring activities, and any relevant behavioral patterns or responses observed. The alert also provides context-sensitive information based on the individual's profile, recent life events, or typical daily routines that might be pertinent to the current situation. Additionally, the system includes specific, actionable instructions for the contact individual, such as recommended immediate steps, alternative contact methods, and guidelines for escalation if initial attempts to reach the target individual are unsuccessful. To ensure the alert's effectiveness, it is typically sent through multiple communication channels (e.g., text message, email, automated voice call) based on the contact individual's preferences and the urgency of the situation. The system also logs the alert's dispatch time and method, and may require confirmation of receipt, ensuring a closed-loop communication process that maximizes the chances of timely intervention when needed.

In step 130, an update alert is sent. The update includes a comprehensive summary of the target individual's status over a predetermined period. This update provides a holistic view of the individual's status and any significant developments. The alert typically begins with an overview of the monitoring period, such as “Monthly Status Update for [Target Individual's Name],” followed by a concise yet thorough summary of the individual's overall status. This summary includes key metrics like response rates to check-ins, general mood trends, and any notable changes in behavior or routine. The update then details any issues detected during the monitoring period, ranging from minor concerns to more significant events that required intervention. These might include instances of delayed responses, unusual message content, or periods of non-responsiveness. The alert also highlights notable events, both positive and concerning, such as successful completion of health-related goals, or any reported wellness incidents. To enhance its utility, the update may include visualizations like graphs or charts illustrating trends over time. Additionally, it often concludes with recommendations for adjustments to the monitoring plan or suggestions for follow-up actions. This comprehensive update alert ensures that caregivers and designated contacts maintain a clear, data-driven understanding of the individual's status, enabling proactive care, timely interventions when necessary, and peace of mind.

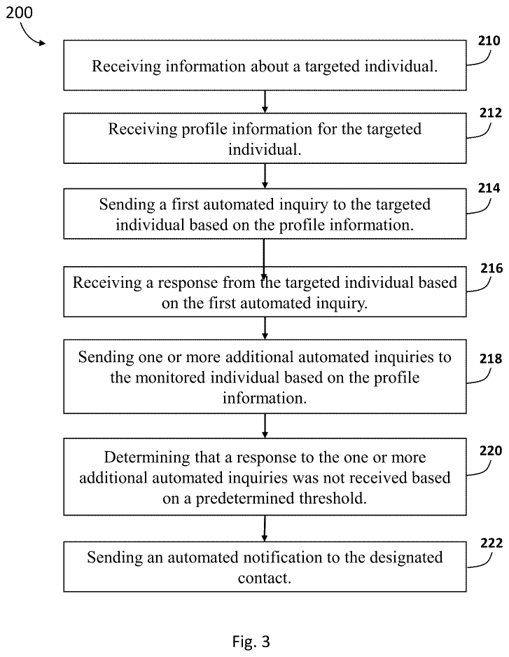

FIG. 3 shows an example method 200 for monitoring the status of an individual in accordance with the present disclosure. The method may be implemented on a mobile device, wearable technology, server, cloud-based platforms, computer system, or system capable of processing data and communicating over a network.

In step 210, the mobile device receives information about a targeted individual. The information about the targeted individual includes contact information of an individual to be monitored and a designated contact for the individual.

In step 212, the mobile device receives profile information for the targeted individual. The profile information includes information about communication preferences for the targeted individual.

In step 214, the mobile device sends a first automated inquiry to the targeted individual based on the profile information.

In step 216, the mobile device receives a response from the targeted individual based on the first automated inquiry.

In step 218, the mobile device sends one or more additional automated inquiries to the monitored individual based on the profile information.

In step 220, the mobile device determines that a response to the one or more additional automated inquiries was not received based on a predetermined threshold.

In step 222, the mobile device sends an automated notification to the designated contact.

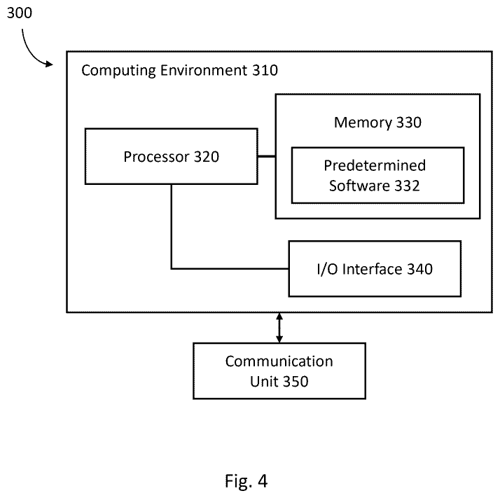

FIG. 4 shows a computing system 300 that is part of the system for monitoring the status of an individual in accordance with the present disclosure. The computing system 300 can be part of the monitoring unit 14, computing unit 12, mobile device 18, or any other computing device in monitoring system 10. According to example embodiments shown schematically in FIG. 4, the computing system 300 includes a computing environment 310 and a communication unit 350. The computing environment 310 includes a processor 320, a memory 330, and an I/O interface 340. The computing environment 310 is coupled to the communication unit 350 through the I/O interface 340.

The processor 320 can typically control the overall operations of the computing environment 310, such as the operations associated with data acquisition, data processing, and data communications. The processor 320 can include one or more processors to execute instructions to perform all or some of the steps in the above-described methods. Moreover, the processor 320 can include one or more modules that facilitate the interaction between the processor 320 and other components. The processor may be or include a central processing unit (CPU), a microprocessor, a single chip machine, a graphical processing unit (GPU), System on a Chip (SoC), Tensor Processing Unit (TPU), Quantum Processor, Vision Processing Unit (VPU) or the like.

The memory 330 can store various types of data to support the operation of the computing environment 310. The Memory 330 can include predetermined software 331. Examples of such data comprise instructions for any applications or methods operated on the computing environment 310, user data, profile data, communication preferences, inquiry schedules, response histories, alert thresholds, notification templates, emergency contact information, and system configuration settings etc. The memory 330 may be implemented by using any type of volatile or non-volatile memory devices, or a combination thereof, such as a static random-access memory (SRAM), Dynamic Random-Access Memory (DRAM), an electrically erasable programmable read-only memory (EEPROM), an erasable programmable read-only memory (EPROM), a programmable read-only (PROM), an erasable programmable read-only memory (EPROM), a programmable read-only memory (PROM), a read-only memory (ROM), a magnetic memory, a flash memory, a magnetic or optical disk.

The I/O interface 340 can provide an interface between the processor 320 and peripheral interface modules, such as RF circuitry, external port, proximity sensor, audio and speaker circuitry, video and camera circuitry, microphone, accelerometer, display controller, optical sensor controller, intensity sensor controller, other input controllers, keyboard, a click wheel, buttons, Touchscreen Controller, Pressure Sensor, Light Emitting Diode (LED) Controller, Universal Serial Bus (USB) Controller, Serial Peripheral Interface (SPI) Bus Controller, Digital-to-Analog Converter (DAC), Analog-to-Digital Converter (ADC), Radio Frequency Identification (RFID) Reader/Writer and the like. The buttons may include but are not limited to, a home button, a power button, and volume buttons.

Communication unit 350 provides communication between the processing unit, an external device, mobile device, and a webserver (or cloud). The communication can be done through, for example, WIFI or BLUETOOTH hardware protocols, Cellular Networks (4G LTE, 5G), NFC (Near Field Communication), Radio Frequency Identification (RFID), Satellite Communication, Ethernet or the like. The communication unit 350 can be within the computing environment or connected to it.

In one or more embodiments, the computing environment 310 can be coupled to a user interface that can include a speaker, lights, display, haptic feedback motor, Gesture Recognition System, Tactile Feedback Devices, Biometric Sensors, Voice Recognition System or other similar technologies for communicating with the user.

In some embodiments, there is also provided a non-transitory computer-readable storage medium comprising a plurality of programs, such as comprised in the memory 330, executable by the processor 320 in the computing environment 310, for performing the above-described methods. For example, the non-transitory computer-readable storage medium may be a ROM, a RAM, or the like.

The non-transitory computer-readable storage medium has stored therein a plurality of programs for execution by a computing device having one or more processors, where the plurality of programs for execution by a computing device having one or more processors, where the plurality of programs when executed by the one or more processors, cause the computing device to perform the above-described method for motion prediction.

In some embodiments, the computing environment 310 may be implemented with one or more application-specific integrated circuits (ASICs), digital signal processors (DSPs) digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

This invention represents an improvement in the technology of monitoring an individual's status and well-being. Unlike traditional systems that rely on wearable devices or complex home sensor networks, this solution leverages existing communication channels and methods to provide a non-intrusive, yet highly effective monitoring system. It addresses key limitations of current technologies, such as the need for consistent device usage or the installation of expensive equipment. By utilizing customizable, automated check-ins through familiar communication methods like text messages, emails, and phone calls, the system ensures higher compliance and ease of use, particularly for elderly or technologically challenged individuals. The system's flexibility in communication preferences, alert thresholds, and designated contact notifications offers a more personalized and responsive approach to status monitoring. This innovative combination of accessibility, customization, and intelligent analysis represents an improvement over existing solutions, offering a more comprehensive, user-friendly, and adaptable tool for keeping track of an individual's status and well-being.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein. In addition, while the invention has been described in terms of several preferred embodiments, it should be understood that there are many alterations, permutations, and equivalents that fall within the scope of this invention. It should also be noted that there are alternative ways of implementing both the process and apparatus of the present invention. For example, steps do not necessarily need to occur in the orders shown in the accompanying figures, and may be rearranged as appropriate. It is therefore intended that the appended claim includes all such alterations, permutations, and equivalents as fall within the true spirit and scope of the present invention.

What is claimed is:

1. A method for monitoring the status of an individual, comprising:
receiving information about a targeted individual, wherein the information about the targeted individual comprises contact information of an individual to be monitored and a designated contact for the individual;
receiving profile information for the targeted individual, wherein the profile information comprises information about communication preferences for the targeted individual;
sending a first automated inquiry to the targeted individual based on the profile information;
receiving a response from the targeted individual based on the first automated inquiry;
sending one or more additional automated inquiries to the monitored individual based on the profile information;
determining that a response to the one or more additional automated inquiries was not received based on a predetermined threshold; and
sending an automated notification to the designated contact.

2. The method of claim 1, wherein the contact information comprises the targeted individuals mobile phone number or email address.

3. The method of claim 1, wherein the communication preferences for the targeted individual comprises predetermined message text and a predetermined time of day to send communications to the targeted individual.

4. The method of claim 1, wherein the predetermined threshold comprises a predetermined amount of time from an automated inquiry being sent and no response being received.

5. The method of claim 1, wherein the automated notification comprises an alert about the targeted individual based on the profile information.

6. The method of claim 5, wherein the profile information comprises a predetermined alert text message.

7. The method of claim 1, wherein receiving the response from the targeted individual based on the first automated inquiry comprises:
receiving a text response from the targeted individual based on the first automated inquiry;
determining that the text response includes a non-standard response; and
sending the text response to the designated contact with the first automated inquiry.

8. A computing device comprising:
one or more processors;
a non-transitory computer-readable storage medium storing instructions executable by the one or more processors, wherein the one or more processors are configured to:
receive information about a targeted individual, wherein the information about the targeted individual comprises contact information of an individual to be monitored and a designated contact for the individual;
receive profile information for the targeted individual, wherein the profile information comprises information about communication preferences for the targeted individual;
send a first automated inquiry to the targeted individual based on the profile information;
receive a response from the targeted individual based on the first automated inquiry;
send one or more additional automated inquiries to the monitored individual based on the profile information;
determine that a response to the one or more additional automated inquiries was not received based on a predetermined threshold; and
send an automated notification to the designated contact.

9. The computing device of claim 8, wherein the contact information comprises the targeted individuals mobile phone number or email address

10. The computing device of claim 8, wherein the communication preferences for the targeted individual comprises predetermined message text and a predetermined time of day to send communications to the targeted individual.

11. The computing device of claim 8, wherein the predetermined threshold comprises a predetermined amount of time from an automated inquiry being sent and no response being received.

12. The computing device of claim 8, wherein the automated notification comprises an alert about the targeted individual based on the profile information.

13. The computing device of claim 12, wherein the profile information comprises a predetermined alert text message.

14. The computing device of claim 8, wherein the one or more processors configured to receive the response from the targeted individual based on the first automated inquiry are further configured to:
receive a text response from the targeted individual based on the first automated inquiry;
determine that the text response includes a non-standard response; and
send the text response to the designated contact with the first automated inquiry.

15. A non-transitory computer-readable storage medium storing a plurality of programs for execution by a computing device having one or more processors, wherein the plurality of programs, when executed by the one or more processors, cause the computing device to perform:
receiving information about a targeted individual, wherein the information about the targeted individual comprises contact information of an individual to be monitored and a designated contact for the individual, wherein the contact information comprises the targeted individuals mobile phone number or email address;
receiving profile information for the targeted individual, wherein the profile information comprises information about communication preferences for the targeted individual;
sending a first automated inquiry to the targeted individual based on the profile information;
receiving a response from the targeted individual based on the first automated inquiry;
sending one or more additional automated inquiries to the monitored individual based on the profile information;
determining that a response to the one or more additional automated inquiries was not received based on a predetermined threshold; and
sending an automated notification to the designated contact.

16. The non-transitory computer-readable storage medium of claim 15, wherein the communication preferences for the targeted individual comprises predetermined message text and a predetermined time of day to send communications to the targeted individual.

17. The non-transitory computer-readable storage medium of claim 15, wherein the predetermined threshold comprises a predetermined amount of time from an automated inquiry being sent and no response being received.

18. The non-transitory computer-readable storage medium of claim 15, wherein the automated notification comprises an alert about the targeted individual based on the profile information.

19. The non-transitory computer-readable storage medium of claim 15, wherein the automated notification comprises an alert about the targeted individual based on the profile information, and wherein the profile information comprises a predetermined alert text message.

20. The non-transitory computer-readable storage medium of claim 15, further comprising:
receiving a text response from the targeted individual based on the first automated inquiry;
determining that the text response includes a non-standard response; and
sending the text response to the designated contact with the first automated inquiry.
